(19) United States
(12) Patent Application Publication
(10) Pub. No.: US 2008/0261796 A1
(43) Pub. Date: Oct. 23, 2008

(54) RESISTANCE PASTE FOR HIGH-POWER THICK FILM CIRCUITS BASED ON A STAINLESS STEEL SUBSTRATE AND PREPARATION METHOD THEREOF

(76) Inventors: Shenghong Wu, Dongguan City (CN); Taijun Deng, Dongguan City (CN); Qingju Ning, Dongguan City (CN)

Correspondence Address: BYIP, LTD., P.O. BOX 1484, GENERAL POST OFFICE, HONG KONG, CN

(21) Appl. No.: 12/045,651

(22) Filed: Mar. 10, 2008

(30) Foreign Application Priority Data
Apr. 23, 2007 (CN) 200710027659.6

(51) Int. Cl. C03C 14/00

(52) U.S. Cl. 501/32

(57) ABSTRACT

The present invention relates to a resistance paste for a high-power thick film circuit based on a stainless steel substrate and a preparation method thereof The resistance paste disclosed in the present invention demonstrates a low resistivity, excellent insulating performance, superior printing and sintering characteristics, and good compatibility with a surface-insulated stainless steel substrate. The preparation method of the present invention comprises steps of: A. Preparing a microcrystalline glass powder; B. Preparing an organic binder; C. Formulating a paste: preparing a solid-phase component with the silver powder, the palladium powder and the microcrystalline glass powder in appropriate proportions; mixing in a ball mill tank the solid-phase component and the organic binder in an appropriate proportion; and putting the resultant mixture into a ball mill to be grounded therein. In the present invention, a microcrystalline glass is selected as a binding phase, and a resistance trace layer made therefrom exhibits an expansion coefficient compatible with the stainless steel and can be well bonded with the stainless steel. The resistance trace layer thus obtained has advantages of low resistance, good compatibility with dielectric materials and electrode pastes used in thick film circuits based on a stainless steel substrate, and satisfactory conductivity.

### CROSS-REFERENCE TO RELATED APPLICATION

The present patent application claims priority of Chinese Patent Application No. 200710027659.6 filed Apr. 23, 2007.

### FIELD OF INVENTION

The present invention relates to a resistance paste for a high-power (tens of watts to several kilowatts) thick film circuit based on a stainless steel substrate, and particularly, relates to a resistance paste for a high-power thick film circuit based on a stainless steel (grades 430, 444 and so on) substrate and a preparation method thereof.

### DESCRIPTION OF RELATED ART

Currently, there exist two kinds of traditional substrates in the field of thick film circuits, the polymeric substrates and the ceramic substrates. Unfortunately, both of them suffer from respective limitations. Specifically, the polymer substrates have a low thermal conductivity, a high expansion coefficient, and poor stability at high temperature (>100° C.). On the other hand, the ceramic substrates, including Al₂O₃ substrates, AlN substrates and the like, can only be manufactured with a small size generally no larger than 100×100 mm², and have poor mechanical properties, making it difficult to assemble. In contrast, surface-insulated stainless steel substrates developed in recent years have raised increasingly more concerns because of their comprehensive advantages such as superior mechanical strength, satisfactory thermal properties, electromagnetic shielding characteristics, large sizes, complicated profiles and potentially reduced costs. A surface-insulated stainless steel substrate has the following technical features. With a stainless steel material being used as a substrate, a dielectric paste possessing physical properties compatible with the stainless steel material is sprayed onto the substrate and then sintered to form a compact insulating layer featuring a high binding strength, and satisfactory insulating and breakdown characteristics (the breakdown voltage is as high as 3750V, much higher than the value of 1250V provided by conventional printed dielectric pastes).

As the surface-insulated stainless steel substrates demonstrate such unique characteristics as superior mechanical and thermal properties, and allow to be manufactured with large sizes and complicated profiles, a special attention has been directed to the possibility of their use in high-power thick film devices. Currently, components occupying large areas, such as high-power resistors (100˜1000 W), high-power heating elements (100˜1000 W) and the like, are generally wound by resistance wires. Consequently, such components inevitably have an oversized dimension and a relatively short service life, and are also difficult to design, all being in contradiction with the more and more stringent requirements on miniaturization, high reliability and long service life of various electrical apparatuses. On the other hand, the increasingly sophisticated preparation and application technologies related to the thick film circuit elements have made it possible to develop dielectric materials and thick film resistance pastes having properties compatible with those of the surface-insulated stainless steel substrates, so that high-power thick film elements with small sizes, planar profiles, high reliability and long service life can be designed and manufactured with low cost to meet the ever-increasing market demands.

Resistance traces and electrode traces of high-power thick film resistance elements and heating elements are prepared by screen-printing and sintering a resistance paste and an electrode paste respectively.

Because the stainless steel substrate has a larger expansion coefficient than the ceramic substrate, the resistance film layer sintered should also have a large expansion coefficient to match that of the stainless steel. Meanwhile, the glass material in the paste should be chemically compatible with the dielectric material based on the stainless steel substrate and the solid-phase components of the electrode paste.

### SUMMARY OF THE PRESENT INVENTION

In view of the problems existing in the prior art, one objective of the present invention is to provide a resistance paste for a thick film circuit and a preparation method thereof, wherein the resistance paste has a low resistivity, excellent insulating performance, superior printing and sintering properties, and good compatibility with a surface insulated thick film circuits.

To this end, the resistance paste for a high-power thick film circuit based on a stainless steel substrate of the present invention is achieved by the following technical solutions:

A resistance paste for a high-power thick film circuit based on a stainless steel substrate, characterized in that a dielectric material is primarily composed of a microcrystalline glass which is prepared by melting nonmetallic oxides in appropriate proportions, comprising:

the dielectric material is composed of a solid-phase component consisting of a silver powder, a palladium powder and the microcrystalline glass powder, and an organic cementing agent, wherein a proportion by weight of the solid-phase component to the organic cementing agent is

70˜90:30˜10;

a proportion by weight of the silver and palladium powders to the microcrystalline glass powder in the solid-phase component is

60˜99:40˜1;

the silver powder and the palladium powder both have a particle size less than 2 μm, and are added in a proportion by weight of

1˜10:99˜90.

Further, the microcrystalline glass is a microcrystalline glass of the SiO₂˜Al₂O₃˜Cao˜Bi₂O₃ series, wherein each of the raw materials has the following weight percentages respectively:

SiO₂: 10˜40%;

Al₂O₃: 10˜30%;

Bi₂O₃: 1˜15%;

CaO: 20˜40%;

TiO₂: 0.5˜10%.

The binder has the following components in respective weight percentages:

Terpineol: 85˜98%;

Ethyl cellulose: 2˜5%;

Hydrogenated castor oil: 0.1˜5%;

Soybean lecithin: 0.1˜5%.

A method of preparing a resistance paste for a high-power thick film circuit based on a stainless steel substrate, comprising the following steps:

1.) initially, preparing a microcrystalline glass powder, wherein the following nonmetallic raw materials are mixed in respective weight percentages and stirred homogenously in a mixer:

| | | | |
|---|---|---|---|
| SiO₂: | 10~40%, | Al₂O₃: | 10~30%, |
| CaO: | 20~40%, | Bi₂O₃: | 1~15%, |
| TiO₂: | 0.5~10%, | | |

the resultant mixture is then put into a high-temperature electric furnace to be molten at a temperature of 1200˜1600° C. for 1˜6 hours, and is subsequently poured into water for water quench to get glass slag, which is then loaded into a ball mill to be ground into a microcrystalline glass power having a particle size no more than 5 μm;

2.) then preparing silver and palladium powders, wherein a silver powder and a palladium powder selected to have a granularity of less than 2 μm are mixed in a proportion by weight of

1˜10:99˜90,

to get the desired silver and palladium powders ready for use;

3.) next, formulating an organic binder, wherein the following materials acting as an organic binder, a thickener, a surfactant and a thixotropic agent respectively are solved together in corresponding weight percentages at 80˜100° C. for several hours:

| | | | |
|---|---|---|---|
| Terpineol: | 85~98%, | Ethyl cellulose: | 2~5%, |
| Hydrogenated castor oil: | 0.1~5%, | Soybean lecithin: | 0.1~5%; |

4.) finally preparing a paste, wherein the silver and palladium powders and the microcrystalline glass powder are mixed in a proportion by weight of

60˜99:40˜1

to get a solid-phase component, and then the solid-phase component and the organic binder are put into a container in a proportion by weight of

70˜90:30˜10

to be stirred and dispersed therein, and the resultant mixture is then ground in a ball mill to finally obtain the resistance paste.

The present invention solves the above-mentioned technical problems, and has the following advantages compared to conventional resistance pastes based on a stainless steel substrate:

1. A microcrystalline glass is selected as a binding phase, and a resistance trace layer composed of a microcrystalline glass especially of the SiO2˜Al2O3˜CaO˜Bi2O3 series and the silver and palladium powders exhibits an expansion coefficient compatible with the stainless steel and can be well bonded with the stainless steel.

2. Multi-component alcohols and esters are adopted as a main solvent instead of the conventional single-component alcohols, and components with different boiling points and evaporation rates of the main solvent are added in reasonable proportions, so that the resultant paste is volatized evenly, during the printing, drying, sintering and the like processes, thus obviating defects such as cracks and pinholes attributed to concentrative volatilization of the solvent.

3. A hydrogenated castor oil is adopted as a thixotropic agent to form a favorable colloidal structure in the organic binder system, thus obtaining superior thixotropic properties and anti-precipitation performance in the resultant paste.

4. The resistance paste of the present invention delivers good printing and sintering characteristics, and a resistance trace layer made of the resistance paste enjoys advantages of low resistance, good compatibility with dielectric materials and electrode pastes used in thick film circuits based on a stainless steel substrate, and satisfactory conductivity.

### DETAILED DESCRIPTION OF THE PREFERRED EMBODIMENT

A further description will now be made on the present invention with reference to embodiments thereof.

A resistance paste for a high-power thick film circuit based on a stainless steel substrate of this invention is composed of a solid-phase component (i.e., silver and palladium powders plus a microcrystalline glass powder) and an organic binder in a proportion by weight of (70˜90):(30˜10), wherein a proportion by weight of the silver and palladium powders to the microcrystalline glass powder in the solid-phase component is (60˜99):(40˜1); both the silver powder and the palladium powder in the silver and palladium powders have a particle size less than 2 μm, and are added in a proportion by weight of (1˜10):(99˜90).

As a further improvement of the present invention, the microcrystalline glass is a microcrystalline glass of the SiO2˜Al2O3˜CaO˜Bi2O3 series, wherein respective weight percentages of each of the raw materials are:

| | | | |
|---|---|---|---|
| SiO2: | 10~40%; | Al2O3: | 10~30%; |
| CaO: | 20~40%; | Bi2O3: | 1~15%; |
| TiO2: | 0.5~10%. | | |

Respective weight percentages of each of the components in the organic binder are: terpineol (85˜98%), ethyl cellulose (2˜5%), hydrogenated castor oil (0.1˜5%), and soy lecithin (0.1˜5%).

A method of preparing a resistance paste for a high-power thick film circuit based. on a stainless steel substrate of the present invention comprises the following steps:

1.) preparing a microcrystalline glass powder, wherein the following materials are mixed in corresponding weight percentages and stirred homogenously in a mixer: SiO2 (10˜40%), Al2O3 (10˜30%), CaO (20˜40%), Bi2O3 (1˜15%), TiO2 (0.5˜10%), and are then put into a high-temperature electric furnace to be molten at a temperature of 1200˜1600° C. for 1˜6 hours. Subsequently, the molten materials are poured into water for water quench to get glass slag, which is then loaded into a ball mill to be ground into a microcrystalline glass power with a particle size of no more than 5 μm.

2.) then preparing silver and palladium powders, wherein a palladium powder and a silver powder selected to have a granularity of less than 2 μm respectively are mixed in a proportion by weight of (1˜10):(99˜90) to get the desired silver and palladium powders ready for use.

3.) next, formulating the organic binder, wherein the following materials acting as an organic binder, a thickener, a surfactant and a thixotropic agent respectively are solved together in corresponding weight percentages at 80˜100° C. for several hours:

| | | | |
|---|---|---|---|
| Terpineol | (85~98%) | Ethyl cellulose | (2~5%) |
| Hydrogenated castor oil | (0.1~5%) | Soy lecithin | (0.1~5%); |

4.) finally, formulating a paste in the following way. The silver and palladium powders and the microcrystalline glass powder are mixed in a proportion by weight of

(60˜99):(40˜1)

to get a solid-phase component. The resultant solid-phase component and the organic binder are put into a container in a proportion by weight of (70˜90):(30˜10) to be stirred and dispersed therein, and the mixture is ground in a ball mill to obtain a resistance paste.

The resistance paste for a high-power thick film circuit based on a stainless steel substrate of this invention is composed of the solid-phase component and the organic binder in a proportion by weight of (70˜90):(30˜10), wherein the proportion by weight of the silver and palladium powders to the microcrystalline glass powder in the solid-phase component is (60˜99):(40˜1); the silver powder and the palladium powder both have a particle size less than 2 μm and are added in a proportion by weight of (1˜10):(99˜90).

The preparation method of the present invention comprises steps of:
A. Preparing a microcrystalline glass powder;
B. Preparing an organic binder;
C. Formulating a paste: preparing a solid-phase component with the silver powder, the palladium powder and the microcrystalline glass powder in appropriate proportions; mixing in a ball mill tank the solid-phase component and the organic binder in an appropriate proportion; and putting the resultant mixture into a ball mill to be ground therein.

The resistance paste of the invention has advantages of low resistance, good compatibility with the dielectric paste and the electrode paste, and superior resistive performance.

The embodiments described above are only intended to illustrate rather than to limit this invention in any way. Changes and modifications may be made by those of ordinary skill in the art upon reviewing the disclosure of this invention without departing from the scope of this invention. Therefore, all such modifications and changes shall still fall within the scope of this invention.

What is claimed is:

1. A resistance paste for a high-power thick film circuit based on a stainless steel substrate, characterized in that a dielectric material is primarily composed of a microcrystalline glass which is prepared by melting nonmetallic oxides in appropriate proportions, comprising:
the dielectric material is composed of a solid-phase component consisting of a silver powder, a palladium powder and the microcrystalline glass powder, and an organic cementing agent, wherein a proportion by weight of the solid-phase component to the organic cementing agent is
70˜90:30˜10;
a proportion by weight of the silver and palladium powders to the microcrystalline glass powder in the solid-phase component is
60˜99:40˜1;
the palladium powder and the silver powder in the silver and palladium powders both have a particle size less than 2 μm, and the proportion by weight of the palladium powder to the silver powder is
1˜10:99˜90.

2. The resistance paste for a high-power thick film circuit based on a stainless steel substrate according to claim 1, characterized in that the microcrystalline glass is a microcrystalline glass of the SiO₂˜Al₂O₃˜Cao˜Bi₂O₃ series, wherein each of the raw materials has the following weight percentages respectively:
SiO₂: 10˜40%;
Al₂O₃: 10˜30%;
Bi₂O₃: 1˜15%;
CaO: 20˜40%;
TiO₂: 0.5˜10%.

3. The resistance paste for a high-power thick film circuit based on a stainless steel substrate according to claim 1, characterized in that the binder has the following components in respective weight percentages:
Terpineol: 85˜98%;
Ethyl cellulose: 2˜5%;
Hydrogenated castor oil: 0.1˜5%;
Soybean lecithin: 0.1˜5%.

4. A method of preparing a resistance paste for a high-power thick film circuit based on a stainless steel substrate, comprising the following steps:
1.) initially, preparing a microcrystalline glass powder, wherein the following nonmetallic raw materials are mixed in respective weight percentages and stirred homogenously in a mixer:

| | | | |
|---|---|---|---|
| SiO₂: | 10~40%, | Al₂O₃: | 10~30%, |
| CaO: | 20~40%, | Bi₂O₃: | 1~15%, |
| TiO₂: | 0.5~10%, | | |

the resultant mixture is then put into a high-temperature electric furnace to be molten at a temperature of 1200˜1600° C. for 1˜6 hours, and is subsequently poured into water for water quench to get glass slag, which is then loaded into a ball mill to be ground into a microcrystalline glass power having a particle size no more than 5 μm;
2.) then preparing silver and palladium powders, wherein a silver powder and a palladium powder selected to have a granularity of less than 2 μm are mixed in a proportion by weight of
1˜10:99˜90,
to get the desired silver and palladium powders ready for use;
3.) next, formulating an organic binder, wherein the following materials acting as an organic binder, a thickener, a surfactant and a thixotropic agent respectively are solved together in corresponding weight percentages at 80˜100° C. for several hours:

| | | | |
|---|---|---|---|
| Terpineol: | 85~98%, | Ethyl cellulose: | 2~5%, |
| Hydrogenated castor oil: | 0.1~5%, | Soybean lecithin: | 0.1~5%; |

4.) finally preparing a paste, wherein the silver and palladium powders and the microcrystalline glass powder are mixed in a proportion by weight of
60˜99:40˜1
to get a solid-phase component, and then the solid-phase component and the organic binder are put into a container in a weight proportion of
70˜90:30˜10
to be stirred and dispersed therein, and the resultant mixture is then ground in a ball mill to finally obtain the resistance paste.
